(19) United States
(12) Patent Application Publication
(10) Pub. No.: US 2016/0063926 A1
(43) Pub. Date: Mar. 3, 2016

(54) DISPLAY SYSTEM

(71) Applicant: BOE TECHNOLOGY GROUP CO., LTD., Beijing (CN)

(72) Inventors: Lijie ZHANG, Beijing (CN); Peng CHENG, Beijing (CN)

(21) Appl. No.: 14/565,664

(22) Filed: Dec. 10, 2014

(30) Foreign Application Priority Data
Aug. 28, 2014 (CN) 201410431489.8

(51) Int. Cl. G09G 3/34

(52) U.S. Cl. CPC G09G 3/3406; G09G 2320/0242; G09G 2320/062

(57) ABSTRACT

A display system is disclosed. Light emitting diodes and laser diodes are used to provide backlight sources for the display panel. A first driving unit configured for driving light emitting diodes to emit light and a second driving unit configured for driving laser diodes to emit light are provided accordingly. A control module acquires image signals to be displayed in the display panel and determines whether the image to be displayed need to be compensated for its picture quality; if so, the control module controls a first driving unit and a second driving unit to drive light emitting diodes and laser diodes respectively to emit light together; and if not, only controls a first driving unit to drive light emitting diodes to emit light. The display system can effectively increase color gamut range of a liquid crystal display.

### TECHNICAL FIELD

Embodiments of the present invention relate to a display system.

### BACKGROUND

As is well known, liquid crystal displays have incomparable advantages over many other displays such as low power consumption, small volume, light weight and ultrathin screen, and have been widely applied in intelligent instruments and meters controlled by monolithic computers and low power consumption electronic products in recent years. At present, most liquid crystal displays in the market use light emitting diodes as backlight sources for realizing wide color gamut of liquid crystal displays.

Traditional liquid crystal displays have a color gamut of up to about 70%. With the increasing demand for quality of display pictures, traditional liquid crystal displays are incapable of meeting people's requirements. According to optic and chromaticity principles, it is possible to combine a blue LED with fluorescent powders that can be effectively excited by blue light to emit yellow light so as to form a white LED. However, the fluorescent powders have a limited color purity in that red light can not be emitted during the excitation of blue light which impedes effective improvement of visual color saturation of the displayed pictures. In order to increase the color gamut, a process of sticking a thin film onto a surface of liquid crystal display is proposed, which however would influence the brightness and color of pictures displayed by the liquid crystal display.

Therefore, a problem to be addressed is to increase color gamut of a liquid crystal display so as to ensure the quality of displayed pictures.

### SUMMARY

Embodiments of the present invention provide a display system comprising: a display panel; a backlight module using light emitting diodes and laser diodes as backlight sources; a first driving unit configured for driving the light emitting diodes to emit light; a second driving unit configured for driving the laser diodes to emit light; and a control module connected with the first driving unit and the second driving unit respectively.

The control module is configured to acquire image signals to be displayed in the display panel and determine whether the image to be displayed need to be compensated for in terms of picture quality; if so, the control module controls the first driving unit and the second driving unit to drive the light emitting diodes and the laser diodes respectively to emit light together; and if not, only controls the first driving unit to drive the light emitting diodes to emit light.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 schematically illustrates a block diagram of a display system provided in an embodiment of the present invention;

FIGS. 2, 3 and 4 schematically illustrates block diagrams of the display system provided in other embodiments of the present invention respectively.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

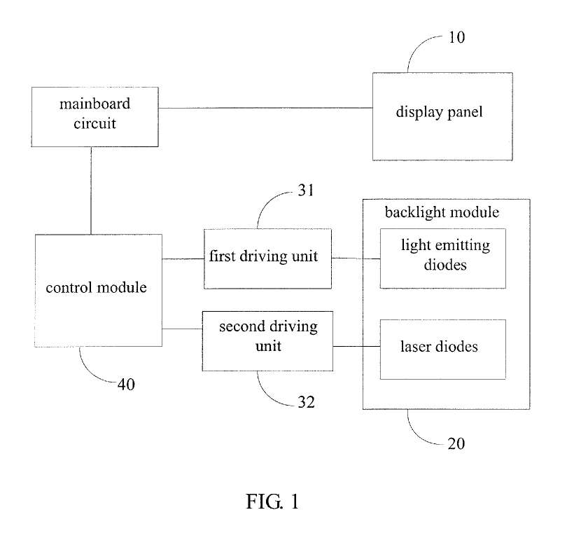

An embodiment of the present invention provide a display system as illustrated in FIG. 1, comprising: a display panel 10, a backlight module 20 with light emitting diodes and laser diodes as backlight sources, a first driving unit 31 configured for driving the light emitting diodes to emit light, a second driving unit 32 configured for driving the laser diodes to emit light, and a control module 40 connected with the first driving unit 31 and the second driving unit 32.

The control module 40 is configured to acquire image signals to be displayed in the display panel 10 and determine whether the image to be displayed need to be compensated for in terms of picture quality; if so, control the first driving unit 31 and the second driving unit 32 to drive the light emitting diodes and the laser diodes respectively to emit light together; and if not, only control the first driving unit 31 to drive the light emitting diodes to emit light.

For example, as illustrated in FIG. 1, a mainboard circuit configured for controlling display panel for image display is further provided in the display system. Specifically, the mainboard circuit is configured to acquire and process exterior image signals to be displayed, and send processed image signals to the display panel 10 for image display. At the same time, the mainboard circuit simultaneously sends processed signals to the control module 40. The control module 40 in turn acquires, analyzes and processes the image signals to be displayed, determine whether the image to be displayed need to compensated for in terms of picture quality, and control corresponding driving units to drive respective diodes for normal display of images.

In the above-mentioned display system provided in embodiments of the present invention, light emitting diodes and laser diodes are used to provide backlight for the display panel 10, accordingly, the first driving unit 31 configured for driving light emitting diodes to emit light and the second driving unit 32 configured for driving laser diodes to emit light are also provided. The control module 40 acquires image signals to be displayed in the display panel 10 and determines whether the image to be displayed need to be compensated for in terms of picture quality; if so, controls the first driving unit 31 and the second driving unit 32 to drive light emitting diodes and laser diodes respectively to emit light together; and if not, only controls the first driving unit 31 to drive light emitting diodes to emit light. Compared to a known liquid crystal displays in which only light emitting diodes is used as the backlight sources for the display panel 10, the present embodiment can effectively increase color gamut range of the liquid crystal display, effectively increase the color saturation of displayed images, improve image definition quite well and obtain more realistic and hierarchical displayed images.

Modules of the above-mentioned display system will be described in detail below.

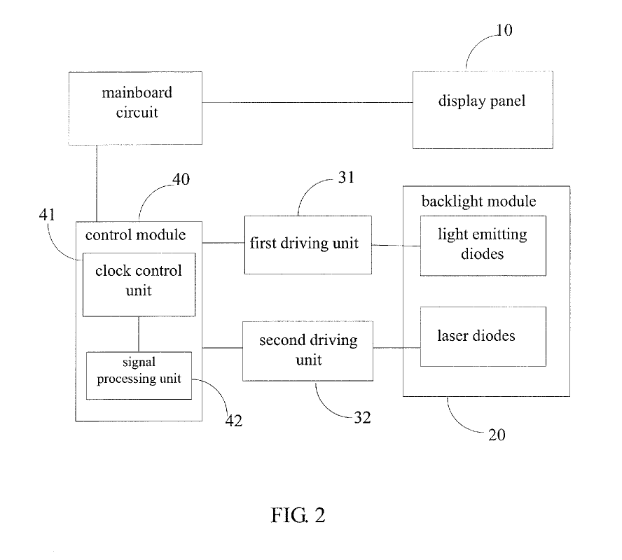

In the above-mentioned display system provided in the embodiment of the present invention, the control module 40 needs to acquire and process image signals to be displayed and determine whether the images to be displayed need to be compensated for in terms of picture quality. In an exemplary implementation, as illustrated in FIG. 2, the control module 40 comprises a clock control unit 41 and a signal processing unit 42. The signal processing unit 42 is configured to acquire color signals and brightness signals of the image to be displayed, analyze and process them. The clock control unit 41 is configured to determine, according to signals analyzed and processed by the signal processing unit 42, whether or not to control the second driving unit 32 to drive laser diodes to emit light, if so, control the first driving unit 31 and the second driving unit 32 to drive light emitting diodes and laser diodes respectively to emit light together for compensating the image to be displayed for picture quality; and if not, only control the first driving unit 31 to drive light emitting diodes to emit light.

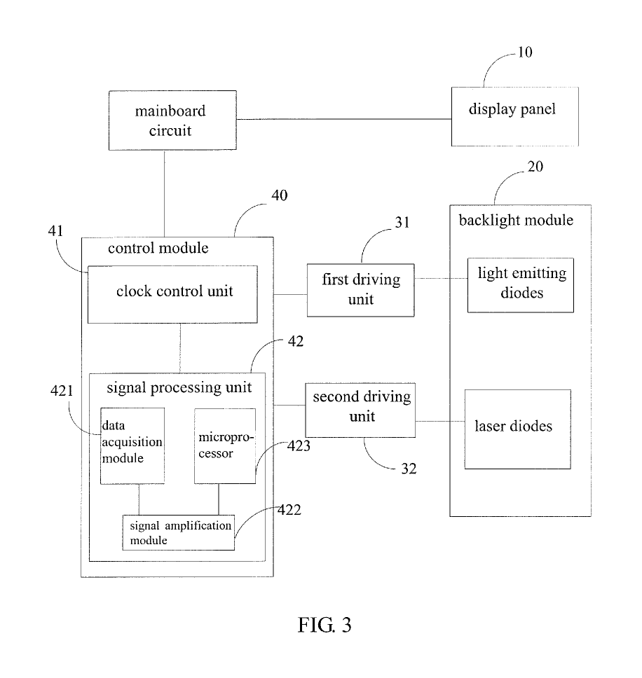

In the above-mentioned display system provided in the embodiment of the present invention, acquisition and processing of signals of the image to be displayed is implemented by the signal processing unit 42 in the control module 40. In an exemplary implementation, as illustrated in FIG. 3, the signal processing unit 42 comprises: a data acquisition module 421, a signal amplification module 422 and a microprocessor 423, where the data acquisition module 421 acquires color signals and brightness signals of the image to be displayed and sends the acquired signals to the signal amplification module 422 for amplification; the microprocessor 423 further analyzes and processes signals amplified by the signal amplification module 422 and sends the processed signals to the clock control unit 41 that determines whether or not to compensate the image to be displayed for picture quality according to signals processed by the microprocessor 423, namely, whether or not to control the second driving unit 32 to drive laser diodes to emit light.

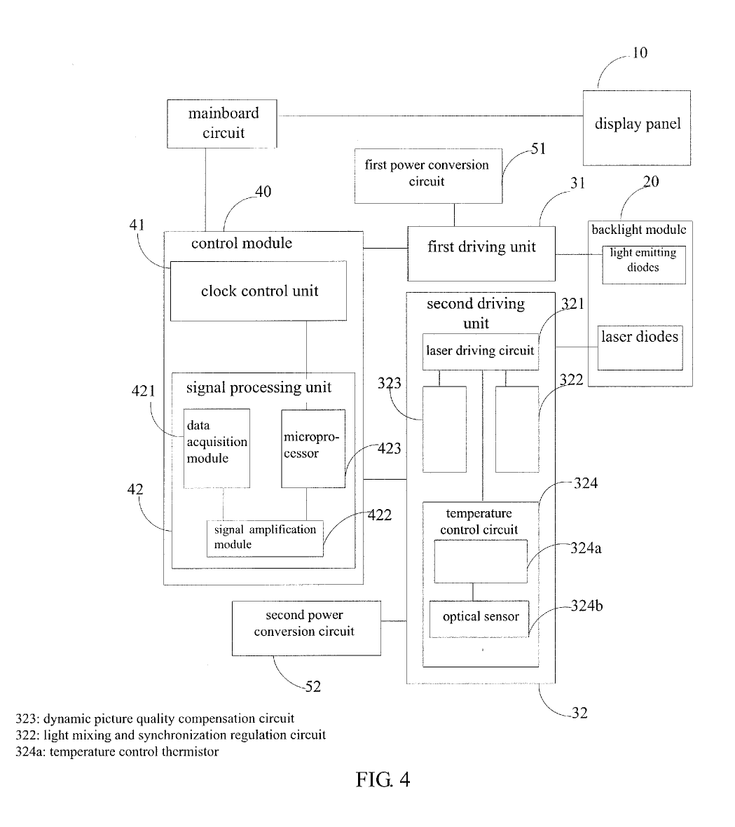

In the above-mentioned display system provided in the embodiment of the present invention, when the second driving unit 32 drives laser diodes to emit light, it needs to emit light synchronously with light emitting diodes, moreover, the laser diodes suffer large reduction of service life due to temperature influence, therefore, a temperature controlling module needs to be further provided in the second driving unit 32. In an exemplary implementation, as illustrated in FIG. 4, the second driving unit 32 comprises: a laser driving circuit 321, a light mixing and synchronization regulation circuit 322, a dynamic picture quality compensation circuit 323 and a temperature controlling circuit 324. The laser driving circuit 321 drives laser diodes to emit light. The light mixing and synchronization regulation circuit 322 controls the laser driving circuit 321 to drive laser diodes to emit light synchronously with light emitting diodes. The dynamic picture quality compensation circuit 323 controls the laser driving circuit 321 to drive laser diodes while implementing picture quality compensation. The temperature controlling circuit 324 controls the laser driving circuit 321 to regulate light intensity of the laser diodes. In this way, it is possible to implement dynamic quality compensation, reduce power consumption and prolong service life of laser diodes.

In the above-mentioned display system provided in the embodiment of the present invention, the temperature controlling circuit 324 is configured for guaranteeing service life of laser diodes. In an exemplary implementation, as illustrated in FIG. 4, the temperature controlling circuit 324 comprises a temperature controlling thermistor 324a and an optical sensor 324b. The optical sensor 324b converts laser driving voltage signals into pulse-width modulation signals, and transmits them to the temperature controlling thermistor 324a; the temperature controlling thermistor 324a in turn controls the laser driving circuit 321 to regulate light intensity of the laser diodes in terms of the pulse-width modulation signals transmitted from the optical sensor 324b. In this way, the power consumption is reduced and the service life of laser diodes is prolonged.

In an exemplary implementation, in the above-mentioned display system provided in embodiments of the present invention, the light emission mode for laser diodes is impulse light emission.

In the known liquid crystal displays, color saturation of displayed images can not satisfy human eye's visual enjoyment because the backlight sources can not effectively excite red light. In the above-mentioned display system provided in embodiments of the present invention, laser diodes emitting red light are adopted in order to realize picture quality compensation for displayed images. In this way, while compensating for picture quality of displayed images, laser diodes and light emitting diodes emit light synchronously, which can effectively increase color gamut range of the liquid crystal display, effectively increase color saturation of images, improve picture definition quite well and obtain more realistic and hierarchical displayed images.

In an exemplary implementation, as illustrated in FIG. 4, the above-mentioned display system provided in embodiments of the present invention further comprises: a first power conversion circuit 51 configured for providing constant current supply for the first driving unit 31, and a second power conversion circuit 52 configured for providing constant current supply for the second driving unit 32. Since the current for driving laser diodes are larger and the voltage required for driving laser diodes is about 5V, the first power conversion circuit 51 configured for providing constant current supply for the first driving unit 31 driving light emitting diodes and the second power conversion circuit 52 configured for providing constant current supply for the second driving unit 32 driving laser diodes can not be the same power supply and should be separated and designed independently to satisfy current magnitudes required for light emitting diodes and laser diodes to emit light respectively.

Embodiments of the present invention provide a display system in which light emitting diodes and laser diodes are used to provide backlight sources for the display panel, a first driving unit configured for driving light emitting diodes to emit light and a second driving unit configured for driving laser diodes to emit light are provided accordingly, a control module acquires image signals to be displayed in the display panel and determines whether the image to be displayed need to be compensated for in terms of picture quality; if so, controls the first driving unit and the second driving unit to drive light emitting diodes and laser diodes respectively to emit light together; and if not, only controls the first driving unit to drive light emitting diodes to emit light. Compared to the known liquid crystal displays with only light emitting diodes for providing backlight sources for the display panel, it can effectively increase color gamut range of the liquid crystal display, effectively improve the color saturation of displayed images, improve image definition quite well and obtain more realistic and hierarchical displayed images.

What are described above is related to the illustrative embodiments of the disclosure only and not limitative to the scope of the disclosure; the scopes of the disclosure are defined by the accompanying claims.

The present application is based on and claims priority of China patent application No. 201410431489.8 filed on Aug. 28, 2014, which is incorporated herein in its entirety by reference.

1. A display system, comprising:
a display panel;
a backlight module using light emitting diodes and laser diodes as backlight sources;
a first driving unit configured for driving the light emitting diodes to emit light;
a second driving unit configured for driving the laser diodes to emit light; and
a control module connected with the first driving unit and the second driving unit respectively;
wherein the control module is configured to acquire signals of image to be displayed in the display panel and determine whether the image to be displayed need to be compensated for its picture quality; if so, the control module controls the first driving unit and the second driving unit to drive the light emitting diodes and the laser diodes respectively to emit light together; and if not, the control module only controls the first driving unit to drive the light emitting diodes to emit light.

2. The display system of claim 1, wherein the control module comprises a clock control unit and a signal processing unit;
wherein the signal processing unit is configured to acquire, analyze and process color signals and brightness signals of the image to be displayed;
the clock control unit is configured to determine whether or not to control the second driving unit to drive the laser diodes to emit light according to signals analyzed and processed by the signal processing unit.

3. The display system of claim 2, wherein the signal processing unit comprises a data acquisition module, a signal amplification module and a microprocessor;
wherein the data acquisition module is configured to acquire color signals and brightness signals of the image to be displayed;
the signal amplification module is configured to amplify signals acquired by the data acquisition module;
the microprocessor is configured to analyze and process signals amplified by the signal amplification module and transmit processed signals to the clock control unit.

4. The display system of claim 1, wherein the second driving unit comprises: a laser driving circuit, a light mixing and synchronization regulation circuit, a dynamic picture quality compensation circuit and a temperature control circuit;
wherein the laser driving circuit is configured to drive the laser diodes to emit light;
the light mixing and synchronization regulation circuit is configured to control the laser driving circuit to drive the laser diodes such that the light of the laser diodes is emitted synchronously with the light emitting diodes;
the dynamic picture quality compensation circuit is configured to control the laser driving circuit to drive the laser diodes while picture quality compensation is performed;
the temperature control circuit is configured to control the laser driving circuit to regulate light intensity of the laser diodes.

5. The display system of claim 4, wherein the temperature control circuit comprises a temperature controlling thermistor and an optical sensor;
wherein the optical sensor is configured to convert laser driving voltage signals into pulse-width modulation signals and transmit them to the temperature controlling thermistor card;
the temperature controlling thermistor is configured to control the laser driving circuit according to the pulse-width modulation signals transmitted by the optical sensor to regulate light intensity of the laser diodes.

6. The display system of claim 1, wherein a light emission mode of the laser diodes is impulse light emission mode.

7. The display system of claim 6, wherein the light emitted by the laser diodes is red light.

8. The display system of claim 1, further comprising: a first power conversion circuit and a second power conversion circuit;
wherein the first power conversion circuit is configured to provide constant current supply for the first driving unit; and
the second power conversion circuit is configured to provide constant current supply for the second driving unit.
